(19) United States
(12) Patent Application Publication
(10) Pub. No.: US 2026/0202036 A1
(43) Pub. Date: Jul. 16, 2026

(54) VEHICLE LAMP

(71) Applicant: Ichikoh Industries, Ltd., Isehara-shi (JP)

(72) Inventor: Takayuki KAWAMURA, Isehara-shi (JP)

(73) Assignee: Ichikoh Industries, Ltd., Isehara-shi (JP)

(21) Appl. No.: 19/137,339

(22) PCT Filed: Dec. 15, 2023
(86) PCT No.: PCT/JP2023/044977

§ 371 Date: Jun. 10, 2025

(30) Foreign Application Priority Data
Dec. 16, 2022 (JP) 2022-201498

(51) Int. Cl. F21S 45/47; F21S 41/20; F21S 41/25; F21S 41/29

(52) U.S. Cl. CPC F21S 45/47; F21S 41/25; F21S 41/285; F21S 41/295

(57) ABSTRACT

Provided is a vehicle lamp in which heat is less likely to be trapped and thermal deformation of a condenser lens and a projection lens is prevented. A vehicle lamp includes a light source unit, a support portion, a condenser lens, a light blocking member, and a projection lens. A first lens portion, a first lens peripheral wall portion, and the light blocking member (shade portion) form a first space. A second lens portion, a second lens peripheral wall portion, and the light blocking member (shade portion) form a second space. An upper portion of at least the first lens peripheral wall portion or the second lens peripheral wall portion has an upper opening (upper opening of first lens peripheral wall portion, upper opening of second lens peripheral wall portion).

### TECHNICAL FIELD

The present invention relates to a vehicle lamp.

### BACKGROUND ART

Vehicle lamps that form an irradiation pattern on a road surface in the vicinity of a vehicle are known. For example, a vehicle lamp described in PTL 1 includes a light source unit, a support portion that supports the light source unit, a condenser lens that collects light emitted from the light source unit, a light blocking member that has an irradiation slit that allows part of the light collected by the condenser lens to pass through, a projection lens that projects the light passing through the light blocking member to form an irradiation pattern, and a housing that houses these components. The housing has an enclosed space.

### CITATION LIST

### Patent Literature

PTL 1: Japanese Unexamined Patent Publication No. 2020-205237

### SUMMARY OF THE INVENTION

### Problems to be Solved by the Invention

In a vehicle lamp, the temperature increases due to heat generated by a light source unit and heat generated from light emitted from the light source unit, and the heat is more likely to be trapped inside. It has been found that in particular, in a light blocking member, light strikes a large area and a temperature increase is more likely to occur, and this may cause thermal deformation of a condenser lens and a projection lens that are located in the periphery of the light blocking member.

An object of the present invention is to provide a vehicle lamp in which heat is less likely to be trapped inside and thermal deformation of a condenser lens and a projection lens is prevented.

### Means for Solving the Problem

In order to achieve the above object, a vehicle lamp according to a first aspect of the present invention includes: a light source unit; a support portion that supports the light source unit; a condenser lens that collects light emitted from the light source unit; a light blocking member that has an irradiation slit that allows part of the light collected by the condenser lens to pass through; and a projection lens that projects the part of the light passing through the light blocking member to form an irradiation pattern, wherein the condenser lens has a first lens portion, and a first lens peripheral wall portion that extends from the first lens portion as a bottom, the projection lens has a second lens portion, and a second lens peripheral wall portion that extends from the second lens portion as a bottom, the first lens portion, the first lens peripheral wall portion, and the light blocking member form a first space, the second lens portion, the second lens peripheral wall portion, and the light blocking member form a second space, and an upper portion of at least one of the first lens peripheral wall portion and the second lens peripheral wall portion has an upper opening.

A second aspect of the present invention is the vehicle lamp according to the first aspect in which a lower portion of the at least one of the first lens peripheral wall portion and the second lens peripheral wall portion having the upper opening has a lower opening.

A third aspect of the present invention is the vehicle lamp according to the first or second aspect in which the first lens peripheral wall portion has a first upper opening that is formed in the upper portion of the first lens peripheral wall portion and communicates with the first space, and a first lower opening that is formed in a lower portion of the first lens peripheral wall portion and communicates with the first space, and the second lens peripheral wall portion has a second upper opening that is formed in the upper portion of the second lens peripheral wall portion and communicates with the second space, and a second lower opening that is formed in a lower portion of the second lens peripheral wall portion and communicates with the second space.

A fourth aspect of the present invention is the vehicle lamp according to any one of the first to third aspects in which the support portion has a mounted portion and a heat dissipation portion, the condenser lens has a first lens mounting portion that extends in a width direction intersecting an optical axis direction, from an end portion of the first lens peripheral wall portion, the light blocking member has a light blocking member mounting portion that extends in the width direction, the projection lens has a second lens mounting portion that extends in the width direction from an end portion of the second lens peripheral wall portion, and the condenser lens, the light blocking member, and the projection lens are fixed to the mounted portion while the first lens mounting portion, the light blocking member mounting portion, and the second lens mounting portion are overlapped in this order.

A fifth aspect of the present invention is the vehicle lamp according to any one of the first to fourth aspects in which the projection lens is made of a material different from a material of the condenser lens.

A sixth aspect of the present invention is the vehicle lamp according to any one of the first to fifth aspects in which the condenser lens is made of polycarbonate, and the projection lens is made of acrylic.

A seventh aspect of the present invention is the vehicle lamp according to any one of the first to sixth aspects in which the second lens peripheral wall portion has the upper opening.

### Effect of the Invention

In the present invention, heat is less likely to be trapped inside, and thermal deformation of a condenser lens and a projection lens is prevented.

### BRIEF DESCRIPTION OF THE DRAWINGS

FIG. 1 is an explanatory diagram illustrating a state in which vehicle lamps according to the present embodiment are mounted on a vehicle and form the respective irradiation patterns.

FIG. 2 is a perspective view of a configuration of one of the vehicle lamps.

FIG. 3 is an exploded perspective view of the vehicle lamp illustrated in FIG. 2.

FIG. 4 is a front view of the vehicle lamp illustrated in FIG. 2.

FIG. 5 is an end surface view taken along line V-V illustrated in FIG. 4.

FIG. 6 illustrates a comparative example of the vehicle lamp in FIG. 5, and is an end surface view at the same position as in FIG. 5 of a vehicle lamp that does not have a first upper opening, a first lower opening, a second upper opening, or a second lower opening.

### MODE FOR CARRYING OUT THE INVENTION

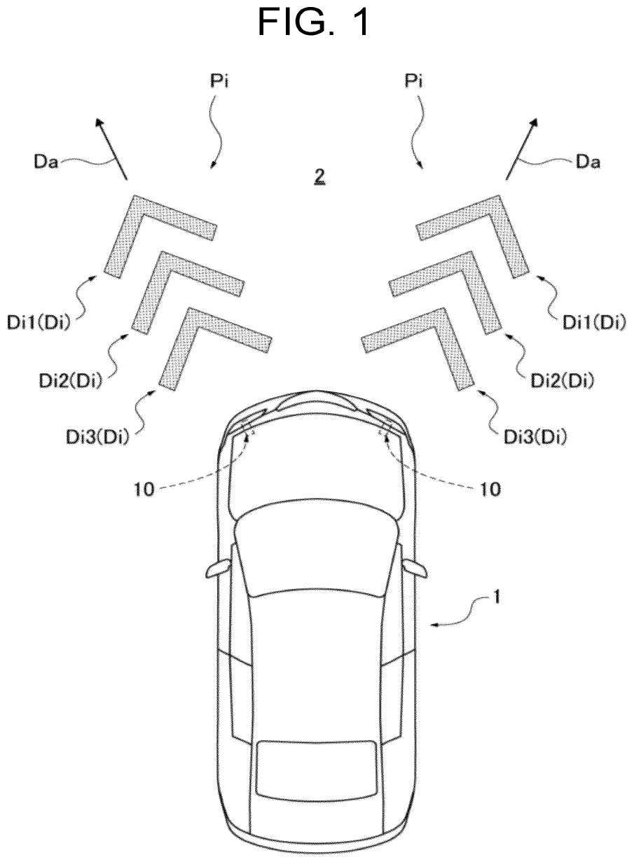

An embodiment of a vehicle lamp according to the present invention will be described below with reference to the drawings. In FIG. 1, in order to facilitate understanding of the state in which the vehicle lamps 10 are provided, the vehicle lamps 10 are emphasized with respect to a vehicle 1 and do not necessarily match the actual state.

As illustrated in FIG. 1, each of the vehicle lamps 10 according to the present embodiment is used as a lamp of the vehicle 1 such as an automobile, and is provided in a front portion of the vehicle 1 to form an irradiation pattern Pi on a road surface 2 in the vicinity of the front of the vehicle 1, separately from a headlight provided in the vehicle 1. The vicinity of the front of the vehicle 1 always includes a proximate area closer to the vehicle 1 than a headlight area irradiated with light from the headlight provided in the vehicle 1, and may include part of the headlight area. Each of the vehicle lamps 10 may also form the irradiation pattern Pi on the road surface 2 in the vicinity of the rear or side of the vehicle 1, and is not limited to the configuration according to the present embodiment.

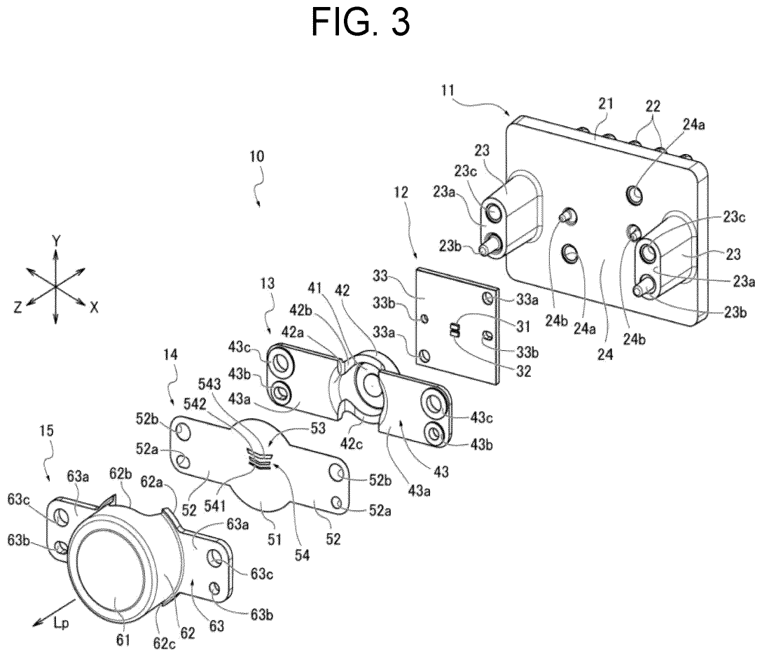

In the present embodiment, the vehicle lamps 10 are disposed at a position higher than the road surface 2 at the front end of the vehicle 1. In the vehicle 1, each of the vehicle lamps 10 is inclined with respect to the road surface 2 so that a projection optical axis Lp (see FIGS. 3 and 5 and the like) is directed toward the road surface 2. The two vehicle lamps 10 have basically the same configuration except for a difference in the mounting position and the position where the irradiation pattern Pi is formed.

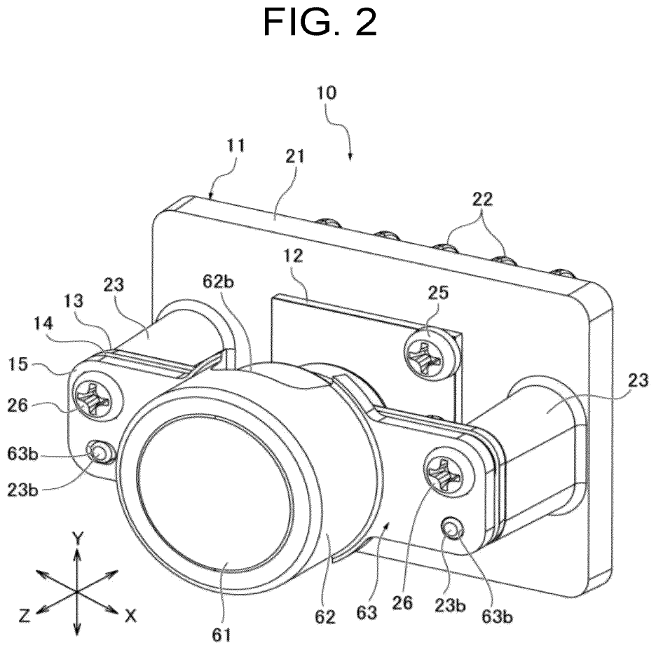

In the following description, in each of the vehicle lamps 10, an optical axis direction (Z), an up-down direction (Y), and a width direction (X) are defined as illustrated in FIGS. 2 to 5. That is, the optical axis direction (Z) is a direction in which the projection optical axis Lp extends, i.e., a direction in which light is emitted (projected), the up-down direction (Y) is a direction perpendicular to the optical axis direction (Z), and the width direction (X) is a direction perpendicular to the optical axis direction and the up-down direction.

As illustrated in FIGS. 2 and 3, in each of the vehicle lamps 10, a light source unit 12, a condenser lens 13, a shade (light blocking member) 14, and a projection lens 15 are attached to an installation base portion (support portion) 11 to form a single projection optical system and constitute a projector-type road surface projection unit.

The installation base portion 11 is a portion in which the light source unit 12 is provided, and is made of thermally conductive die-cast aluminum or resin, and functions as a heat sink as a whole that releases heat generated in the light source unit 12 to the outside. The installation base portion 11 has a base portion 21, a plurality of heat dissipation fins (heat dissipation portions) 22, and a pair of mounting arm portions (mounted portions) 23.

The base portion 21 has a flat plate shape perpendicular to the optical axis direction, and has a light source mounting portion 24 at a center of the base portion 21. The light source mounting portion 24 defines a portion to which the light source unit 12 is attached, and as illustrated in FIG. 3, the light source mounting portion 24 is a flat surface portion between the pair of mounting arm portions 23, and has a pair of screw holes 24a and a pair of positioning protrusions 24b. The pair of screw holes 24a are provided at diagonal positions in the light source mounting portion 24, and enable fixing by screwing screws 25 (see FIG. 2) into the pair of screw holes 24a. The pair of positioning protrusions 24b are arranged in the width direction in the light source mounting portion 24 and located in the vicinity of the respective mounting arm portions 23, and protrude forward in the optical axis direction. Each of the heat dissipation fins 22 has a plate shape perpendicular to the width direction on the rear side of the base portion 21 (the rear side of the base portion 21 in the optical axis direction (the side opposite to the direction in which light is emitted)). The heat dissipation fins 22 are arranged side by side (in parallel) at predetermined intervals in the width direction. The installation base portion 11 dissipates heat generated in the light source unit 12 installed in the light source mounting portion 24 mainly from the heat dissipation fins 22 to the outside.

The pair of mounting arm portions 23 are provided as a pair on both outer sides of the light source mounting portion 24 in the width direction, and protrude forward from the base portion 21 in the optical axis direction. End portions 23a of the two mounting arm portions 23 on the front side in the optical axis direction are flat surface portions perpendicular to the optical axis direction, and the end portions 23a are located at the same level (on the same plane) in the optical axis direction. Each of the end portions 23a has a positioning protrusion 23b and a screw hole 23c. In each of the end portions 23a, the positioning protrusion 23b is provided in a lower portion of the end portion 23a in the up-down direction, and protrudes forward in the optical axis direction. In each of the end portions 23a, the screw hole 23c is provided in an upper portion of the end portion 23a in the up-down direction, and the condenser lens 13, the shade 14, and the projection lens 15 can be fixed by screwing screws 26 into the screw holes 23c.

The light source unit 12 includes a first light source 31, a second light source 32, a connector terminal (not illustrated), and a substrate 33 on which these components are mounted. The first light source 31 and the second light source 32 are composed of a light-emitting element such as a light-emitting diode (LED). In the present embodiment, the first light source 31 and the second light source 32 emit light in amber color (amber light) in a Lambertian distribution around the emission optical axis. The colors (wavelength bands), distribution patterns, number of light sources, and the like of the first light source 31 and the second light source 32 may be appropriately set, and are not limited to the configuration according to the present embodiment.

The connector terminal (not illustrated) is electrically connected to a wiring pattern of the substrate 33, and a connection connector connected to a lighting control circuit is detachably attached to the connector terminal. When the connection connector is attached to the connector terminal, power can be supplied from the lighting control circuit to the light sources 31 and 32 via the wiring pattern.

The substrate 33 is composed of a plate-like aluminum substrate, and the first light source 31 and the second light source 32 are mounted on the substrate 33. The substrate 33 has screw through holes 33a provided at positions on a diagonal line that correspond to the pair of screw holes 24a of the light source mounting portion 24 of the base portion 21 of the installation base portion 11. Furthermore, the substrate 33 has a pair of positioning holes 33b corresponding to the pair of positioning protrusions 24b of the light source mounting portion 24. The substrate 33 is attached to the light source mounting portion 24 by inserting the positioning protrusions 24b through the respective pair of positioning holes 33b, inserting the screws 25 through the respective pair of screw through holes 33a of the four screw through holes 33a that correspond to the pair of screw holes 24a, and screwing the screws 25 into the respective screw holes 24a.

Thus, the substrate 33 causes the light source mounting portion 24, that is, the first light source 31 and the second light source 32 mounted on the light source mounting portion 24, to face the condenser lens 13. The substrate 33 appropriately supplies power from the lighting control circuit via the connector terminal to turn on the first light source 31 and the second light source 32. The substrate 33 may be composed of a glass epoxy substrate.

The condenser lens 13 collects light emitted from the first light source 31 and the second light source 32, and light is collected in the periphery of each of slit portions 54 (described below) on the shade 14, that is, in a portion of the shade 14 in which the slit portions 54 are provided. In the present embodiment, the condenser lens 13 is made of polycarbonate.

The condenser lens 13 has a first lens portion 41, a first lens peripheral wall portion 42, and a first lens mounting portion 43. The first lens portion 41 mainly collects light emitted from the first light source 31 and the second light source 32, and a center portion of the first lens portion 41 is disposed on the projection optical axis Lp while the condenser lens 13 is installed. The first lens peripheral wall portion 42 extends from the first lens portion 41 as a bottom. The first lens mounting portion 43 extends in the width direction from an end portion 42a of the first lens peripheral wall portion 42, and has a pair of first lens mounting pieces 43a.

The two first lens mounting pieces 43a have a plate shape perpendicular to the optical axis direction, and can be disposed to overlap with the end portions 23a of the two mounting arm portions 23 of the base portion 21 of the installation base portion 11. Each of the first lens mounting pieces 43a has a first lens positioning hole 43b and a first lens screw through hole 43c. While the first lens mounting pieces 43a are overlapped with the end portions 23a, the positioning protrusions 23b can be fitted into the respective first lens positioning holes 43b. While the first lens mounting pieces 43a are overlapped with the end portions 23a, the screws 26 screwed into the screw holes 23c can be inserted through the respective first lens screw through holes 43c. The condenser lens 13 is attached to (the end portions 23a of) the two mounting arm portions 23 of the installation base portion 11 by inserting the positioning protrusions 23b through the respective first lens positioning holes 43b, inserting the screws 26 through the respective first lens screw through holes 43c, and screwing the screws 26 into the respective screw holes 23c.

The end portion 42a of the first lens peripheral wall portion 42 has a pair of cutout portions 42b and 42c having a substantially rectangular shape. The cutout portions 42b and 42c are formed at portions of the end portion 42a that are not provided with the pair of first lens mounting pieces 43a and are located at an upper portion and a lower portion of the end portion 42a while the condenser lens 13 is installed.

The shade 14 is an example of a light blocking member that forms the irradiation pattern Pi by allowing part of light from the first light source 31 and the second light source 32 collected by the condenser lens 13 to pass through an irradiation slit 53. As illustrated in FIG. 1, the irradiation pattern Pi includes three irradiation designs Di that are arranged at substantially equal intervals in a direction away from the vehicle 1.

When the irradiation designs Di are individually referred to, the farthest irradiation design Di from the vehicle 1 is referred as a first irradiation design Di1, the second farthest irradiation design Di from the vehicle 1 is referred as a second irradiation design Di2, and the third farthest irradiation design Di from the vehicle 1 is referred to as a third irradiation design Di3. In the present embodiment, the first irradiation design Dil to the third irradiation design Di3 are each a V-shaped mark, and are arranged in a direction away from the vehicle 1 on the same straight line so as to be viewed as an arrow indicating an arrow direction Da from the vehicle 1.

As illustrated in FIG. 3, the shade 14 is composed of a plate-like member that basically blocks light from passing through, and has a shade portion 51 and a pair of shade mounting pieces 52. The shade mounting pieces 52 protrude from the shade portion 51 toward both sides of the shade portion 51 in the width direction, and can be disposed to overlap with the first lens mounting pieces 43a of the condenser lens 13 attached to the end portions 23a of the two mounting arm portions 23 of the installation base portion 11. Each of the shade mounting pieces 52 has a shade positioning hole 52a and a shade screw through hole 52b.

While the shade mounting pieces 52 are overlapped with the first lens mounting pieces 43a, the positioning protrusions 23b inserted through the first lens mounting pieces 43a can be fitted into the respective shade positioning holes 52a. While the shade mounting pieces 52 are overlapped with the first lens mounting pieces 43a, the screws 26 inserted through the first lens screw through holes 43c can be inserted through the respective shade screw through holes 52b. The shade 14 is attached to the two mounting arm portions 23 of the installation base portion 11 via the condenser lens 13 by inserting the positioning protrusions 23b through the respective shade positioning holes 52a, inserting the screws 26 through the respective shade screw through holes 52b, and screwing the screws 26 into the respective screw holes 23c. When the shade mounting pieces 52 of the shade 14 are attached to the two mounting arm portions 23, a center position of the shade portion 51 is located on the projection optical axis Lp.

The shade 14 is fixed to the condenser lens 13 to form a first space S1 that is surrounded by the first lens portion 41, the first lens peripheral wall portion 42, and the shade portion 51.

The pair of cutout portions 42b and 42c function as openings that communicate with the first space S1. While the condenser lens 13 is installed, the cutout portion 42b that is located in the upper portion serves as a first upper opening 42b, and the cutout portion 42c that is located in the lower portion serves as a first lower opening 42c.

The shade portion 51 has the irradiation slit 53 formed by cutting through part of the plate-like member. The irradiation slit 53 causes the irradiation pattern Pi having a predetermined shape to be projected by allowing part of light from the first light source 31 and the second light source 32 collected by the condenser lens 13 (mainly the first lens portion 41) to pass through. The irradiation slit 53 corresponds to the irradiation pattern Pi, and in the present embodiment, as illustrated in FIG. 3, the irradiation slit 53 is composed of the three slit portions 54.

The three slit portions 54 correspond one to-one to the three irradiation designs Di. The projection lens 15 projects an inverted image through the shade 14 (irradiation slit 53) onto the road surface 2. Thus, the positional relationship of the slit portions 54 is rotationally symmetric around the projection optical axis Lp with respect to the positional relationship of the irradiation designs Di of the irradiation pattern Pi (see FIG. 3). Therefore, of the slit portions 54, a first slit unit 541 at the bottom in the up-down direction corresponds to the first irradiation design Dil of the irradiation pattern Pi, a second slit unit 542 above the first slit unit 541 corresponds to the second irradiation design Di2, and a third slit unit 543 above the second slit unit 542 corresponds to the third irradiation design Di3. The size and interval of the three slit portions 54 are set according to the distance from the road surface 2 so that the irradiation designs Di have the size illustrated in FIG. 1 and are arranged at substantially equal intervals on the road surface 2.

The projection lens 15 projects light passing through the shade 14 onto the road surface 2. In the present embodiment, the projection lens 15 is made of acrylic.

The projection lens 15 has a second lens portion 61, a second lens peripheral wall portion 62, and a second lens mounting portion 63. The second lens portion 61 mainly projects light emitted from the first light source 31 and the second light source 32, and a center portion of the second lens portion 61 is disposed on the projection optical axis Lp while the projection lens 15 is installed. The second lens peripheral wall portion 62 extends from the second lens portion 61 as a bottom. The second lens mounting portion 63 extends in the width direction from an end portion 62a of the second lens peripheral wall portion 62, and has a pair of second lens mounting pieces 63a.

The two second lens mounting pieces 63a have a plate shape perpendicular to the optical axis direction, and can be disposed to overlap with the shade mounting pieces 52 of the shade 14 attached to the end portions 23a of the two mounting arm portions 23 of the base portion 21 of the installation base portion 11. Each of the second lens mounting pieces 63a has a second lens positioning hole 63b and a second lens screw through hole 63c. While the second lens mounting pieces 63a are overlapped with the shade mounting pieces 52, the positioning protrusions 23b inserted through the shade mounting pieces 52 can be fitted into the respective second lens positioning hole 63b. While the second lens mounting pieces 63a are overlapped with the shade mounting pieces 52, the screws 26 inserted through the shade screw through holes 52b can be inserted through the respective second lens screw through hole 63c. The projection lens 15 is attached to (the end portions 23a of) the two mounting arm portions 23 of the installation base portion 11 by inserting the positioning protrusions 23b through the respective second lens positioning hole 63b, inserting the screws 26 through the respective second lens screw through hole 63c, and screwing the screws 26 into the respective screw holes 23c. Thus, the projection optical axis Lp that is the optical axis of the second lens portion 61 of the projection lens 15 is directed in a predetermined direction to set the direction of the projection optical axis Lp of the vehicle lamp 10.

The projection lens 15 is fixed to the shade 14 to form a second space S2 that is surrounded by the second lens portion 61, the second lens peripheral wall portion 62, and the shade portion 51.

The end portion 62a of the second lens peripheral wall portion 62 has a pair of cutout portions 62b and 62c having a substantially rectangular shape. The cutout portions 62b and 62c are formed at portions of the end portion 62a that are not provided with the pair of second lens mounting pieces 63a and are located at an upper portion and a lower portion of the end portion 62a while the projection lens 15 is installed. The pair of cutout portions 62b and 62c function as openings that communicate with the second space S2. While the projection lens 15 is installed, the cutout portion 62b that is located in the upper portion serves as a second upper opening 62b, and the cutout portion 62c that is located in the lower portion serves as a second lower opening 62c.

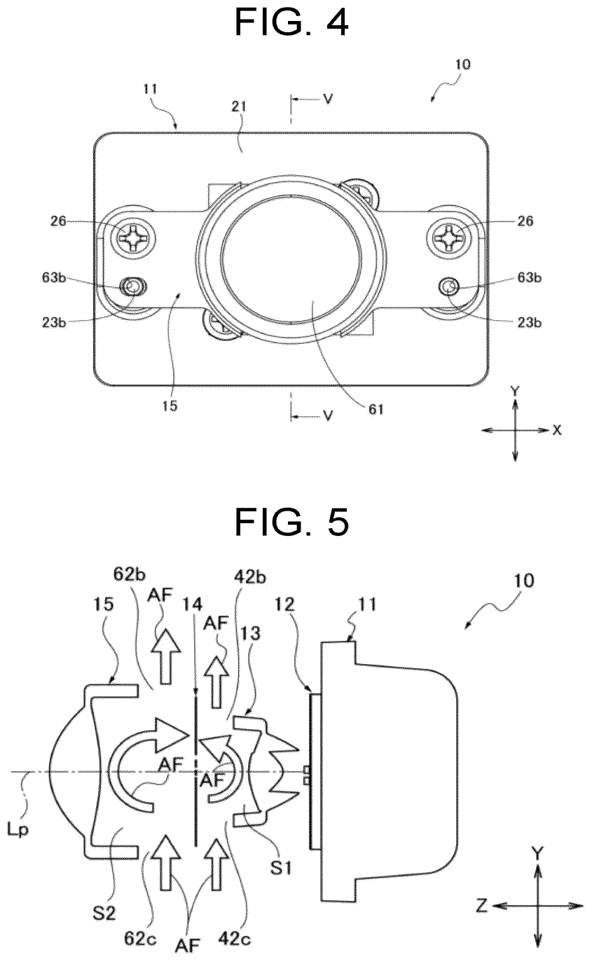

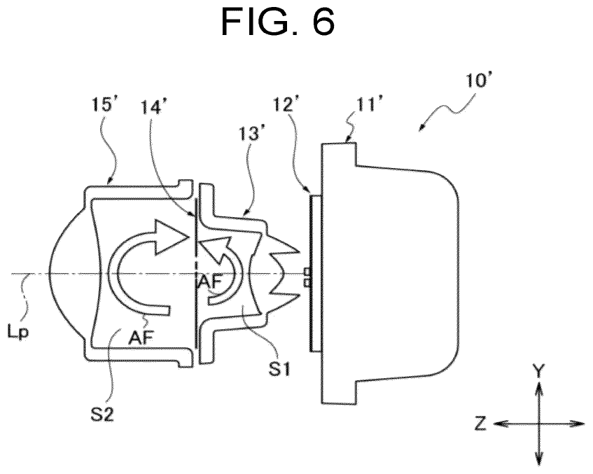

FIG. 4 is a front view of the vehicle lamp illustrated in FIG. 2, and FIG. 5 is an end surface view taken along line V-V illustrated in FIG. 4. FIG. 6 illustrates a comparative example of the vehicle lamp in FIG. 5, and is an end surface view at the same position as in FIG. 5 of a vehicle lamp that does not have a first upper opening, a first lower opening, a second upper opening, or a second lower opening. In FIG. 6, the same members as those illustrated in FIG. 5 are denoted by a “′” sign. In FIGS. 5 and 6, an arrow AF indicates the flow of air in the space.

When the light sources (the first light source 31 and the second light source 32) are turned on by control performed by the lighting control circuit, light is emitted from the light sources. Heat generated by the light source unit and light emitted from the light source unit increase the surrounding temperature. In particular, in the shade 14, light strikes a large area and thus a temperature increase occurs, and this leads to a temperature increase of the air in the first space S1 and the second space S2 that are located in the periphery of the shade 14.

As illustrated in FIG. 6, in a vehicle lamp 10′ that does not have a first upper opening, a first lower opening, a second upper opening, or a second lower opening, the heated air in the first space S1 and the second space S2 is trapped inside, and increases the temperature of a condenser lens 13′ and a projection lens 15′ that are located in the periphery of the first space S1 and the second space S2. This may cause thermal deformation of the condenser lens 13′ and the projection lens 15′.

In contrast, in the vehicle lamps 10 according to the present embodiment, as illustrated in FIG. 5, the first space SI communicates with the outside through the first upper opening 42b and the first lower opening 42c. Thus, when the air in the first space S1 is heated and causes convection, outside air enters the first space S1 through the first lower opening 42c, and the air exits through the first upper opening 42b. Similarly, the second space S2 communicates with the outside through the second upper opening 62b and the second lower opening 62c. Thus, when the air in the second space S2 is heated and causes convection, outside air enters the second space S2 through the second lower opening 62c, and the air exits through the second upper opening 62b. Therefore, it is possible to prevent the temperature increase of the air in the first space S1 and the second space S2, preventing thermal deformation of the condenser lens 13 and the projection lens 15.

The following describes an operation of the vehicle lamps 10.

Each of the vehicle lamps 10 includes: the light source unit 12; the support portion (installation base portion) 11 that supports the light source unit 12; the condenser lens 13 that collects light emitted from the light source unit 12; the light blocking member (shade) 14 that has the irradiation slit 53 that allows part of the light collected by the condenser lens 13 to pass through; and the projection lens 15 that projects the part of the light passing through the light blocking member 14 to form the irradiation pattern Pi, wherein the condenser lens 13 has the first lens portion 41, and the first lens peripheral wall portion 42 that extends from the first lens portion 41 as a bottom, the projection lens 15 has the second lens portion 61, and the second lens peripheral wall portion 62 that extends from the second lens portion 61 as a bottom, the first lens portion 41, the first lens peripheral wall portion 42, and the light blocking member 14 form the first space S1, the second lens portion 61, the second lens peripheral wall portion 62, and the light blocking member 14 form the second space S2, and the upper portion of at least one of the first lens peripheral wall portion 42 and the second lens peripheral wall portion 62 has the upper opening (the first upper opening 42b of the first lens peripheral wall portion 42, the second upper opening 62b of the second lens peripheral wall portion 62).

The heated air in the space (the first space S1 or the second space S2) is released outside through the upper opening (the first upper opening 42b or the second upper opening 62b); thus, heat is less likely to be trapped inside, preventing thermal deformation of the condenser lens 13 and the projection lens 15.

Each of the vehicle lamps 10 may be configured such that the lower portion of the at least one of the first lens peripheral wall portion 42 and the second lens peripheral wall portion 62 having the upper opening has the lower opening (the first lower opening 42c of the first lens peripheral wall portion 42, the second lower opening 62c of the second lens peripheral wall portion 62). The lower opening paired with the upper opening allows the heated air in the space to be more smoothly released outside through the upper opening.

Each of the vehicle lamps 10 may be configured such that the first lens peripheral wall portion 42 has the first upper opening 42b that is formed in the upper portion of the first lens peripheral wall portion 42 and communicates with the first space S1, and the first lower opening 42c that is formed in the lower portion of the first lens peripheral wall portion 42 and communicates with the first space S1, and the second lens peripheral wall portion 62 has the second upper opening 62b that is formed in the upper portion of the second lens peripheral wall portion 62 and communicates with the second space S2, and the second lower opening 62c that is formed in the lower portion of the second lens peripheral wall portion 62 and communicates with the second space S2. The above configuration allows the heated air in the first space SI to be smoothly released outside through the first upper opening 42b and the first lower opening 42c. Furthermore, the configuration allows the heated air in the second space S2 to be smoothly released outside through the second upper opening 62b and the second lower opening 62c.

Each of the vehicle lamps 10 may be configured such that the support portion 11 has the mounted portion (the pair of mounting arm portions) 23 and the heat dissipation portion (the plurality of heat dissipation fins) 22, the condenser lens 13 has the first lens mounting portion 43 that extends in the width direction intersecting the optical axis direction, from the end portion 42a of the first lens peripheral wall portion 42, the light blocking member 14 has the light blocking member mounting portion (shade mounting piece) 52 that extends in the width direction, the projection lens 15 has the second lens mounting portion 63 that extends in the width direction from the end portion 62a of the second lens peripheral wall portion 62, and the condenser lens 13, the light blocking member 14, and the projection lens 15 are fixed to the mounted portion 23 while the first lens mounting portion 43, the light blocking member mounting portion 52, and the second lens mounting portion 63 are overlapped in this order.

The condenser lens 13 and the projection lens 15 may be made of any material that is transparent and allows light to pass through. The raw material may be, for example, polycarbonate or acrylic. The condenser lens 13 and the projection lens 15 may be made of the same type of material or different materials. When the condenser lens 13 and the projection lens 15 are made of different materials, for example, the condenser lens 13 may be made of polycarbonate, focusing on heat resistance, and the projection lens 15 may be made of acrylic, focusing on the degree of transparency. In that case, acrylic is more easily thermally deformed than polycarbonate; thus, when it is necessary to select the position of the upper opening to be formed, it is preferable to form the upper opening in the second lens peripheral wall portion 62 with higher priority.

Although the embodiment of the present invention has been specifically described, needless to say, the present invention is not limited to the embodiment, and modifications may be made within the scope of the technical idea of the present invention.

For example, in the above embodiment, each vehicle lamp has four openings in total, that is, the first upper opening 42b, the first lower opening 42c, the second upper opening 62b, and the second lower opening 62c; however, as described for the operation, the vehicle lamp may have at least an opening in the upper portion of at least one of the first lens peripheral wall portion 42 and the second lens peripheral wall portion 62. Thus, needless to say, the vehicle lamp may have, for example, only the first upper opening 42b or the second upper opening 62b, only the first upper opening 42b and the first lower opening 42c, only the first upper opening 42b and the second upper opening 62b, or only the first upper opening 42b, the first lower opening 42c, and the second upper opening 62b.

In the above embodiment, the first upper opening 42b, the first lower opening 42c, the second upper opening 62b, and the second lower opening 62c are composed of a cutout. However, needless to say, these openings may be any openings communicating with the space (the first space S1 and the second space S2); thus, the openings may be through holes formed in the first lens peripheral wall portion 42 or the second lens peripheral wall portion 62.

### DESCRIPTION OF REFERENCE NUMERALS

10 Vehicle lamp
11 Installation base portion
12 Light source unit
13 Condenser lens
41 First lens portion
42 First lens peripheral wall portion
42a End portion
42b First upper opening (cutout portion)
42c First lower opening (cutout portion)
43 First lens mounting portion
14 Shade (light blocking member)
15 Projection lens
61 Second lens portion
62 Second lens peripheral wall portion
62a End portion
62b Second upper opening (cutout portion)
62c Second lower opening (cutout portion)
63 Second lens mounting portion
S1 First space
S2 Second space

1. A vehicle lamp comprising:
a light source unit;
a support portion that supports the light source unit;
a condenser lens that collects light emitted from the light source unit;
a light blocking member that has an irradiation slit that allows part of the light collected by the condenser lens to pass through; and
a projection lens that projects the part of the light passing through the light blocking member to form an irradiation pattern, wherein
the condenser lens has a first lens portion, and a first lens peripheral wall portion that extends from the first lens portion as a bottom,
the projection lens has a second lens portion, and a second lens peripheral wall portion that extends from the second lens portion as a bottom,
the first lens portion, the first lens peripheral wall portion, and the light blocking member form a first space,
the second lens portion, the second lens peripheral wall portion, and the light blocking member form a second space, and
an upper portion of at least one of the first lens peripheral wall portion and the second lens peripheral wall portion has an upper opening.

2. The vehicle lamp according to claim 1, wherein
a lower portion of the at least one of the first lens peripheral wall portion and the second lens peripheral wall portion having the upper opening has a lower opening.

3. The vehicle lamp according to claim 1, wherein
the first lens peripheral wall portion has a first upper opening that is formed in the upper portion of the first lens peripheral wall portion and communicates with the first space, and a first lower opening that is formed in a lower portion of the first lens peripheral wall portion and communicates with the first space, and
the second lens peripheral wall portion has a second upper opening that is formed in the upper portion of the second lens peripheral wall portion and communicates with the second space, and a second lower opening that is formed in a lower portion of the second lens peripheral wall portion and communicates with the second space.

4. The vehicle lamp according to claim 1, wherein
the support portion has a mounted portion and a heat dissipation portion,
the condenser lens has a first lens mounting portion that extends in a width direction intersecting an optical axis direction, from an end portion of the first lens peripheral wall portion,
the light blocking member has a light blocking member mounting portion that extends in the width direction,
the projection lens has a second lens mounting portion that extends in the width direction from an end portion of the second lens peripheral wall portion, and
the condenser lens, the light blocking member, and the projection lens are fixed to the mounted portion while the first lens mounting portion, the light blocking member mounting portion, and the second lens mounting portion are overlapped in this order.

5. The vehicle lamp according to claim 1, wherein
the projection lens is made of a material different from a material of the condenser lens.

6. The vehicle lamp according to claim 5, wherein
the condenser lens is made of polycarbonate, and
the projection lens is made of acrylic.

7. The vehicle lamp according to claim 6, wherein
the second lens peripheral wall portion has the upper opening.
